(19) United States
(12) Patent Application Publication
(10) Pub. No.: US 2012/0085687 A1
(43) Pub. Date: Apr. 12, 2012

(54) UNIHOUSING PORTABLE WATER FILTRATION SYSTEM

(75) Inventor: Dallas W. Simonette, Las Vegas, NV (US)

(73) Assignee: IPC EAGLE CORPORATION, Eagan, MN (US)

(21) Appl. No.: 13/247,438

(22) Filed: Sep. 28, 2011

Related U.S. Application Data
(60) Provisional application No. 61/391,472, filed on Oct. 8, 2010.

(51) Int. Cl. B01D 63/00

(52) U.S. Cl. 210/96.2; 210/321.78

(57) ABSTRACT

A water improvement/purification container has:
a) an elongated housing;
b) a water entry;
c) two water exit ports adjacent one distal end of the housing;
d) the water port providing supply water first to a macrofilter within the housing;
e) the intermediate water source exiting the macrofilter flowing into a reverse osmosis membrane;
f) the intermediate water being separated into two streams,
g) the first stream being vented through the second of the two water exit ports; and
h) the second stream being vented out of the housing as waste water through the first of the two water exit ports.

### RELATED APPLICATION DATA

This application claims priority from U.S. Provisional Application Ser. No. 61/391,472, filed 8 Oct. 2010.

### BACKGROUND OF THE INVENTION

1. Field of the Invention

The present invention relates to the field of water purification systems, portable purification systems and portable filtration and purification systems that are easily serviced and remove the majority of total dissolved solids from water to be used in portable water application systems such as sprayers and washers.

2. Background of the Art

One significant problem with water-based washing or spraying or cleaning systems is that sources of water may themselves carry contaminants or soluble materials that become deposited on the surfaces—if left to dry by evaporation of the water.

Anyone who has seen “water spots” on glass ware when removed from dishwashing machines is aware of this problem. All untreated water, including rain water, contains dissolved minerals. There are many areas of the country where the materials carried or dissolved in locally available water are so concentrated, that very significant amounts of visible deposits are left on surfaces when washed with water. To avoid this problem, it would be necessary for water to be rapidly removed from washed surfaces without allowing the water to evaporate and leave deposits. Although this can be done by wiping off all collected water or aqueous solutions on the surface after washing, this is a highly labor intensive action and often defeats the objective of attempting to automate or increase the efficiencies of the cleaning processes.

Many different types of cleaning systems and water treatment systems in advance of washing are known in the art, but improved systems are still needed. One of the biggest challenges to the industry is to produce purified water at the lowest cost possible for the given application.

Current state of the art portable systems are still large, heavy and bulky. The need for a reduced size and cost system to further meets the needs of the market is needed and described within this application.

U.S. Pat. No. 7,740,765 (Mitchell et al.) discloses a method of providing potable water that includes providing a filter, passing water through the filter, and removing bacteria and viruses from the water with the filter. The filter comprises a housing having an inlet and an outlet and a filter material disposed within the housing, the filter material formed at least in part from a plurality of filter particles consisting of mesoporous activated carbon. A sum of mesopore and macropore volumes of the filter particles may be between about 0.2 mL/g and about 2 mL/g, wherein mesopore means an intra-particle pore having a diameter between 2 nm and 50 nm, and macropore means an intra-particle pore having a diameter greater than 50 nm, a total pore volume of the filter particles is greater than about 0.4 mL/g and less than about 3 mL/g, and a ratio of the sum of the mesopore and macropore volumes to the total pore volume of the filter particles is greater than about 0.3. The filter removes bacteria and viruses from the water at a level of Filter Bacteria Log Removal of greater than about 2 logs and a Filter Viruses Log Removal of greater than about 1 log.

U.S. Pat. No. 7,604,737 (Francisco et al.) discloses an apparatus for producing purified drinking water. The apparatus comprises a container top including an ultrafiltration insert. The container top attaches to the opening of a liquid holding container, such that liquid from the container passes through a filter. The device includes a mechanism for back flushing or cleaning the filter. The resulting water is substantially pure, being free of bacteria, to make it safe for drinking.

U.S. Pat. No. 7,550,216 (Ofer et al.) discloses composite solid polymer electrolyte membranes (SPEMs) which include a porous polymer substrate interpenetrated with a water soluble ion-conducting material. SPEMs are useful in electrochemical applications, filtering systems including fuel cells and electrodialysis.

U.S. Pat. No. 7,470,366 (Queen at al.) describes water purification systems that include a reverse osmosis unit, a treatment unit, and an electrodeionization unit. A reverse osmosis reject stream from the reverse osmosis unit is treated in the treatment unit and provided to concentrating compartments of the electrodeionization unit.

U.S. Pat. No. 7.179,372 (Miller) discloses a recycling apparatus for recycling wash solution from a power washer: a holding tank constructed and arranged for holding filtered wash solution and having at least one opening to the environment to allow air to freely transfer between the holding tank and the environment; a first filter assembly in gravity feed relation with the holding tank, said first filter assembly having a first filter sheet; a second filter assembly in gravity feed relation with the holding tank, said second filter assembly having a second filter sheet having a filtration size of 10 microns or less, wherein said first and second filter assemblies are constructed and arranged such that during operation a first filtered wash solution from the first filter assembly filters through the second filter assembly to form a recycled wash solution and drops into the holding tank a second distance of from about 1 to about 30 inches before contacting recycled wash solution in the holding tank; and a power washer in communication with the recycled wash solution in the holding tank; and screen structure constructed and arranged for collecting wash solution sprayed from the power washer during operation and transferring the wash solution to the first filter assembly.

U.S. Pat. Nos. 7,014,762 and 6,776,907 (Barlow) shows a device for the deionization of incoming water having: (a) a tank; (b) a generally hollow distributor tube in the tank for ingress into and downward movement of unpurified water through the tank; (c) an opening adjacent the bottom of the generally hollow distributor tube and near the bottom of the tank for distributing the unpurified water out of the generally hollow distributor tube; and (d) a mixed bed of purifying resin within the tank, and surrounding the generally hollow distributor tube, through which the unpurified water travels upwardly, and is deionized to a high purity water by the mixed bed of purifying resin, as it moves upwardly through the mixed bed of purifying resin, after egress from the opening.

All references cited herein are incorporated by reference in their entirities.

### SUMMARY OF THE INVENTION

A water improvement container may be constructed as:
a) an elongated housing;
b) a water entry port adjacent one proximal end of the housing which receives supply water;
c) two water exit ports adjacent one distal end of the housing;
   i) a first of the two water exit ports venting concentrated waste water; and
   ii) a second of the two water exit ports venting product water having significantly lower concentrations of at least some dissolved materials than both the supply water and the waste water;
d) the water port providing supply water first to a combination macrofilter/carbon block filter within the housing that filters at least solid particles and chlorine from the supply water to form an intermediate feed water source for the reverse osmosis membrane; Chlorine is present in most potable water for sanitation purposes and will cause damage to the osmotic membrane material.
e) The intermediate feed water exiting the macrofilter/carbon block filter flows into the inlet side of the reverse osmosis membrane.
f) The first stream of water is the product water from the reverse osmosis membrane is collected in a center core tube and is directed out to the inlet of the ion exchange resin housing
g) The product water may be directed through a series of baffles in the resin bed to ensure maximum contact for full use of the resin. The ion exchange resin removes the balance of the dissolved solids from the product water.
h) The product water flows out from the ion exchange housing and directed to the point of use.
   i) the second stream of water is concentrated water exiting the reverse osmosis membrane. It moves towards the exit port of the main system housing in the gap between the outside diameter of the ion exchange resin bed housing and the inside diameter of the main system housing.
   j) the first stream being vented out of the housing through the second of the two water exit ports; and
   k) the second stream being vented out of the housing as waste water through the first of the two water exit ports.

An alternative way of describing the technology is as a water improvement container having at least:
a) an elongated housing;
b) a water entry port adjacent one proximal end of the housing which receives supply water;
c) two water exit ports adjacent one distal end of the housing;
   i) a first of the two water exit ports venting waste water; and
   ii) a second of the two water exit ports venting product water having lower concentrations of at least some dissolved materials than both the supply water and the waste water;
d) the water port providing supply water first to a macrofilter within the housing that filters at least solid particles and chlorine from the supply water to form an intermediate water source;
e) the intermediate water source exiting the macrofilter flowing into a reverse osmosis membrane
f) the intermediate water being separated into two streams, one stream having at least 70%, preferably at least 85%, more preferably at least 95% and most preferably at least 98%) by weight of dissolved alkaline cationic materials or alkali cationic materials removed from the intermediate water and a second stream having less than 30% (preferably less than 15%, more preferably less than 5% and most preferably less than 2%) by weight of dissolved alkaline cationic materials or alkali cationic materials removed from the intermediate water;
g) the first stream being vented out of the housing through the second of the two water exit ports; and
h) the second stream being vented out of the housing as waste water through the first of the two water exit ports.

The macrofilter may be a fibrous (e.g., non-woven web type filter) or particulate based (bedding of confined particles, such as sand, silicas, carbon, polymers, etc.) filter composition.

The elongate housing may allow the intermediate water source flow into a reverse osmosis membrane assembly. The water flow from the membrane divided into two streams. The first exits out the center core tube and into and through another elongate housing containing ion exchange medium flows into a channel that carries the one stream. The container may have the one stream vented through the second of the two water exit ports as product water. The container may have the second stream vented through the first of two water exit ports as concentrate or waste water.

The ion exchange resin filter may be any anionic or cationic material made of appropriately charged materials, especially polymers, such as charged crosslinked polystyrene polymers.

### BRIEF DESCRIPTION OF THE FIGURES

FIG. 1 shows a cutaway view of a purification system housing according to one embodiment of the present technology.

FIG. 2 shows a detail cutaway view of the supply water end of the system.

FIG. 3 shows a detail cutaway view of the outlet end of the system.

FIG. 4 shows the purification system in the normal operation position.

FIG. 5 shows the purification system with an optional feed water boost pump attached

FIG. 6 shows a portable technology purification system

### DETAILED DESCRIPTION OF THE INVENTION

It is well-known in the art that deionized water can be created by moving tap water through an ion exchange resin bed. In one method, resins fill much of a cylindrical tank.

The resins can be of a mixed bed type. For the purposes of this invention, a “mixed bed resin” is a blend of a cationic and an anionic resin, in an equivalent ratio of 1:1.

In such systems and methods, water enters the top of the cylindrical tank, and moves downwardly through the resin within the tank. When the water has moved through the resin and reached the bottom of the tank, it has been deionized.

At this point, the deionized water flows into slots at the bottom of a hollow tube. The inside of the hollow tube contains no resin, but is typically surrounded by the resin within the tank. After entering the slots at the bottom of the tube, the deionized water moves upwardly through the hollow tube, and out of the tank. This type of system carries with it a low initial equipment investment but a high operating cost to produce the deionized water.

High purity water can also be prepared by deionization through reverse osmosis. In high purity water systems, the ion exchange resin bed and reverse osmosis deionization technologies may be used either separately or together. The reverse osmosis process typically removes 98% of the total dissolved solids from the feed water source. Then the RO product water flows through the ion exchange resin to remove the balance of the dissolved solids. This makes cost of the high purity water very low to produce.

Formally, reverse osmosis is the process of forcing a solvent from a region of high solute concentration through a semipermeable membrane to a region of low solute concentration by applying a pressure in excess of the osmotic pressure.

The carbon filter is the workhorse of a reverse osmosis system. Carbon's unique ability to absorb cancer-causing poisons from water has made it an indispensable part of purification. VOC (volatile organic compounds), THM (trihalomethanes), herbicides, pesticides, organic and inorganic wastes are only a few examples of the contaminates controlled with carbon filtration. Commercial carbon blocks use the highest quality carbon for teir carbon “block” filter. Made from various materials such as coconut shell and wood, the carbon “block” filter is superior because it has more surface area with which water can make contact with carbon. This contact assures better absorption, as well as better smelling and tasting water. The carbon blocks are available with different various structural characteristics. The pore size may vry from 30 micron, to 20 micron, to 10 micron and to even 5 micron or less in commercially available blocks.

The membranes used for reverse osmosis have a dense barrier layer in the polymer matrix where most separation occurs. In most cases, the membrane is designed to allow only water to pass through this dense layer, while preventing the passage of solutes (such as salt ions). This process requires that a high pressure be exerted on the high concentration side of the membrane, usually 2-17 bar (30-250 psi) for fresh and brackish water, and 40-70 bar (600-1000 psi) for seawater, which has around 24 bar (350 psi) natural osmotic pressure that must be overcome. This process is best known for its use in desalination (removing the salt from sea water to get fresh water), but since the early 1970s it has also been used to purify fresh water for medical, industrial, and domestic applications.

Osmosis describes how solvent moves between two solutions separated by a semipermeable membrane to reduce concentration differences between the solutions. When two solutions with different concentrations of a solute are mixed, the total amount of solutes in the two solutions will be equally distributed in the total amount of solvent from the two solutions. Instead of mixing the two solutions together, they can be put in two compartments where they are separated from each other by a semipermeable membrane. The semipermeable membrane does not allow the solutes to move from one compartment to the other, but allows the solvent to move. Since equilibrium cannot be achieved by the movement of solutes from the compartment with high solute concentration to the one with low solute concentration, it is instead achieved by the movement of the solvent from areas of low solute concentration to areas of high solute concentration. When the solvent moves away from low concentration areas, it causes these areas to become more concentrated. On the other side, when the solvent moves into areas of high concentration, solute concentration will decrease. This process is termed osmosis. The tendency for solvent to flow through the membrane can be expressed as “osmotic pressure”, since it is analogous to flow caused by a pressure differential. Osmosis is an example of diffusion.

A semipermeable membrane, also termed a selectively permeable membrane, a partially permeable membrane or a differentially permeable membrane, is a membrane that will allow certain molecules or ions to pass through it by diffusion and occasionally specialized “facilitated diffusion.”

The rate of passage depends on the pressure, concentration, and temperature of the molecules or solutes on either side, as well as the permeability of the membrane to each solute. Depending on the membrane and the solute, permeability may depend on solute size, solubility, properties, or chemistry. How the membrane is constructed to be selective in its permeability will determine the rate and the permeability. Many natural and synthetic materials thicker than a membrane are also semipermeable. One example of this is the thin film on the inside of an egg yolk.

An example of a semi-permeable membrane is the lipid bilayer, on which is based the plasma membrane that surrounds all biological cells. A group of phospholipids (consisting of a phosphate head and two fatty acid tails) arranged into a double-layer, the phospholipid bilayer is a semipermeable membrane which is very specific in its permeability. The hydrophilic phosphate heads are in the outside layer and exposed to the water content outside and within the cell. The hydrophobic tails are the layer hidden in the inside of the membrane. The phospholipid bilayer is the most permeable to small, uncharged solutes. Protein channels float through the phospholipids, and, collectively, this model is known as the fluid mosaic model.

In the process of reverse osmosis, thin film composite membranes (TFC or TFM) are used. These are semipermeable membranes manufactured principally for use in water purification or desalination systems. They also have use in chemical applications such as batteries and fuel cells. In essence, a TFC material is a molecular sieve constructed in the form of a film from two or more layered materials.

Membranes used in reverse osmosis are, in general, made out of polyimide, chosen primarily for its permeability to water and relative impermeability to various dissolved impurities including salt ions and other small molecules that cannot be filtered. Another example of a semipermeable membrane is dialysis tubing.

Other types are cellulose ester membrane (CEM), charge mosaic membrane (CMM), bipolar membrane (BPM), anion exchange membrane (AEM) alkali anion exchange membrane (AAEM) and proton exchange membrane (PEM).

The diffusion of water through a selectively permeable membrane is called osmosis. In reverse osmosis, in a similar setup as that in osmosis, pressure is applied to the compartment with high concentration. In this case, there are two forces influencing the movement of water: the pressure caused by the difference in solute concentration between the two compartments (the osmotic pressure) and the externally applied pressure

Water purification processes are well known and used throughout the world. Water purification is the removal of contaminants from raw water to produce drinking water that is pure enough for human consumption. Substances that are removed during the process include parasites (such as Giardia or Cryptosporidium), bacteria, algae, viruses, fungi, minerals (including toxic metals such as lead, copper and arsenic), and man-made chemical pollutants. Many contaminants can be dangerous. Other contaminants are removed to improve the water's smell, taste, and appearance.

It is not possible to tell whether water is safe to drink just by looking at it. Simple procedures such as boiling or the use of a household charcoal filter are not sufficient for treating water from an unknown source. Even natural spring water considered safe for all practical purposes in the 1800s must now be tested before determining what kind of treatment is needed. Water emerging from shallow groundwater is usually taken from wells or boreholes. The bacteriological quality can be variable depending on the source.

Typically located in the headwaters of river systems, upland reservoirs are usually sited above any human habitation and may be surrounded by a protective zone to restrict the opportunities for contamination. Bacteria and pathogen levels are usually low, but some bacteria, protozoa or algae will be present. Low land surface waters, such as rivers, canals and low land reservoirs, will have a significant bacterial load and may also contain algae, suspended solids and a variety of dissolved constituents. Surface water may be contaminated with biological and chemical pollutants and may potentially transmit diseases such as diarrhea, dysentery, typhoid, cholera and hepatitis. Because of risk of contamination, surface water should never be used for drinking without treatment and/or disinfection.

Many processes are available for purification of water, with their use depending on the particular contaminants present in the water. Ultrafiltration membranes are a relatively new development; they use polymer film having microscopic pores that can be used in place of granular media to filter water effectively without coagulants. The type of membrane media determines how much pressure is needed to drive the water through and what sizes of micro-organisms can be filtered out. In ultrafiltration, hydrostatic pressure forces a liquid against a semipermeable membrane. Suspended solids and solutes of high molecular weight are retained in the filter up to about 0.01 microns in size. This removes bacteria and many viruses (which commonly adhere to the bacteria), but not salts (ions), while water and low molecular weight solutes pass through the membrane.

It is desirable to have a reusable water filtration device that attaches to a water bottle or other portable water container and contains an ultrafiltration membrane. The device may provide a design that allows water to pass through the ultrafiltration membrane with minimal pressure. Preferably, the device includes a flushing mechanism that cleans the ultrafiltration membrane without having to disassemble the bottle cap.

Also, not wishing to be bound by theory, applicants hypothesize that basic activated carbon surfaces may contain the types of functionality that are necessary to attract a larger number of microorganisms compared to those attracted by an acidic carbon surface. This enhanced adsorption onto the basic carbon surfaces might be attributed to the fact that the basic carbon surfaces attract the typically negatively-charged microorganisms and functional groups on their surface. Applicants further hypothesize that basic carbon is capable of producing disinfectants when placed in water by reducing molecular oxygen. Although the final product of the reduction is hydroxide, applicants believe that reactive oxygen intermediates, such as superoxide, hydroperoxide, and/or hydroxy radicals, are formed and maybe sufficiently long-lived to diffuse from carbon into bulk solution.

Furthermore, applicants believe that carbon may become more basic as the bulk oxygen percentage by weight is reduced. A low bulk oxygen percentage by weight may lead to improved bacteria/viruses adsorption because there will be: (1) less carboxylic acids and hence a less negative surface to repel bacteria/viruses; and (2) a less hydrated surface so that water is more easily displaced by bacteria/viruses as they attempt to adsorb to the surface (i.e., less of an energy penalty for the bacteria/virus to displace other species already occupying sites on the surface). This latter reason (i.e., a less hydrated surface) also ties in with the idea that in some embodiments, the surface, discussed hereafter, may be somewhat hydrophobic (that is, it may have just enough oxygen substitution on the edge carbon atoms to allow it to wet out, but not so much as to make it excessively hydrophilic).

The filter particles can be provided in a variety of shapes and sizes. For example, the filter particles can be provided in simple forms such as powder, granules, fibers, blocks and beads. The filter particles can be provided in the shape of a sphere, polyhedron, cylinder, as well as other symmetrical, asymmetrical, and irregular shapes. Further, the filter particles can also be formed into complex forms such as webs, screens, meshes, non-wovens, wovens, and bonded blocks, which may or may not be formed from the simple forms described above Like shape, the size of the filter particle can also vary, and the size need not be uniform among filter particles used in any single filter. In fact, it can be desirable to provide filter particles having different sizes in a single filter. Generally, the size of the filter particles may be between about 0.1 μm and about 10 mm, in some embodiments between about 0.2 μm and about 5 mm, in some embodiments between about 0.4 μm and about 1 mm, and in some embodiments between about 1 .mu.m and about 500 μm. For spherical and cylindrical particles (e.g., fibers, beads, etc.), the above-described dimensions refer to the diameter of the filter particles. For filter particles having substantially different shapes, the above-described dimensions refer to the largest dimension (e.g., length, width, or height).

Several technical approaches towards water purification exist, including the use of ion-exchange resins. However, the need to periodically regenerate ion-exchange resins requires a complex arrangement of pumps, piping, valves, and controls with associated large capital and maintenance costs and the use of regenerating chemicals which must be disposed of as chemical waste.

A water purification system should be energy efficient, i.e., should consume the least amount of energy per unit volume of purified water produced as is possible. Energy can be consumed, for example, in increasing the pressure of a supply stream of water in order to drive permeate through a membrane that filters out impurities, or in applying direct current across electrodes to drive ions into concentrating compartments in an electrodialysis unit. In an electrodialysis unit, it is understood that a large resistance, i.e., a small conductance, across the diluting compartment, the concentrating compartment, or both can result in a large fraction of the electrical energy supplied being dissipated as heat without driving the motion of many ions. This problem can be addressed in part by ensuring a large concentration of ions in the concentrating compartment by, for example, recycling the concentrate effluent stream to the entrance of the concentrating compartment or by adding salt to the concentrating feed stream.

The problem of small conductance across the diluting compartment is addressed with an electrodeionization unit. The basic design of an electrodeionization unit is similar to that of an electrodialysis unit. However, diluting compartments of an electrodeionization unit contain ion-exchange beads which increase conductance across the diluting compartment. The ion-exchange beads have positively and negatively charged sites; these sites facilitate the efficient migration of ions through the diluting compartment even when the conductivity of the diluting feed stream is low. An electrodeionization unit is capable of producing higher purity water than an electrodialysis unit.

A water improvement container may be constructed as:
a) an elongated housing;
b) a water entry port adjacent one proximal end of the housing which receives supply water;
c) two water exit ports adjacent one distal end of the housing;
   i) a first of the two water exit ports venting waste water; and
   ii) a second of the two water exit ports venting product water having significantly lower concentrations of at least some dissolved materials than both the supply water and the waste water;
d) the water port providing supply water first to a combination macrofilter/carbon block filter within the housing that filters at least solid particles and chlorine from the supply water to form an intermediate feed water source for the reverse osmosis membrane; Chlorine is present in most potable water for sanitation purposes and will cause damage to the osmotic membrane material.
e) The intermediate feed water exiting the macrofilter/carbon block filter flows into the inlet side of the reverse osmosis membrane.
f) The first stream of water is the product water from the reverse osmosis membrane is collected in a center core tube and is directed out to the inlet of the ion exchange resin housing
g) The product water may be directed through a series of baffles in the resin bed to ensure maximum contact for full use of the resin. The ion exchange resin removes the balance of the dissolved solids from the product water.
h) The product water flows out from the ion exchange housing and directed to the point of use.
the second stream of water is concentrated water exiting the reverse osmosis membrane. It moves towards the exit port of the main system housing in the gap between the outside diameter of the ion exchange resin bed housing and the inside diameter of the main system housing.
j) the first stream being vented out of the housing through the second of the two water exit ports; and
k) the second stream being vented out of the housing as waste water through the first of the two water exit ports.
l) A boost pump maybe mounted to the elongated housing. The pump receives the water source at its inlet and discharges the water at an increased pressure to the water entry port of the elongated housing. The pump maybe driven by AC electric, DC battery electric or gasoline engine.

The macrofilter may be a fibrous (e.g., non-woven web type filter) or particulate based (bedding of confined particles, such as sand, silicas, carbon, polymers, etc.) filter composition.

The elongate housing may allow the intermediate water source flow into a reverse osmosis membrane assembly. The water flow from the membrane divided into two streams. The first exits out the center core tube and into and through another elongate housing containing ion exchange medium flows into a channel that carries the one stream. The container may have the one stream vented through the second of the two water exit ports as product water. The container may have the second stream vented through the first of two water exit ports as concentrate or waste water. The ion exchange resin filter may be any anionic or cationic material made of appropriately charged materials, especially polymers, such as charged crosslinked polystyrene polymers.

Reference to the Figures will provide additional descriptions and understanding of the practice of the present technology.

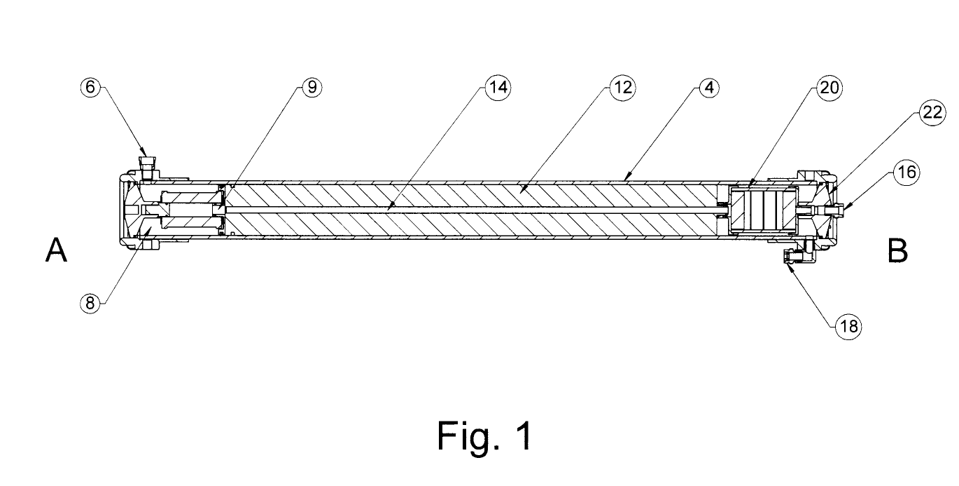

FIG. 1 shows a cutaway view of a purification system housing 2 according to one embodiment of the present technology. The pressure vessel housing 2 has an outer shell 4 having a proximal water input end A and a distal water effluent end B. On the proximal end A of the housing 2 is a supply water port 6 and an interior chamber 8 where water is directed through an initial supply water prefiltering area 10. The pretreated supply water passes through port 9 into a semipermeable membrane 12. The RO product water collects in core tube 14 and flows outward into the ion exchange resin housing 20. The outlet of the ion exchange resin hosing is connected to the main system housing outlet cap 22.

The water passes from the proximal end A to the distal end B of the system housing 2 and in the distal end B, product water which is highly filtered and purified as described herein passes out of supply water port 16, waste water from the outlet end of the reverse osmosis (RO) membrane flows through the gap created between the outside diameter of the ion exchange resin housing 20 and the inside diameter of outer shell 4 and then is vented through exit waste port 18.

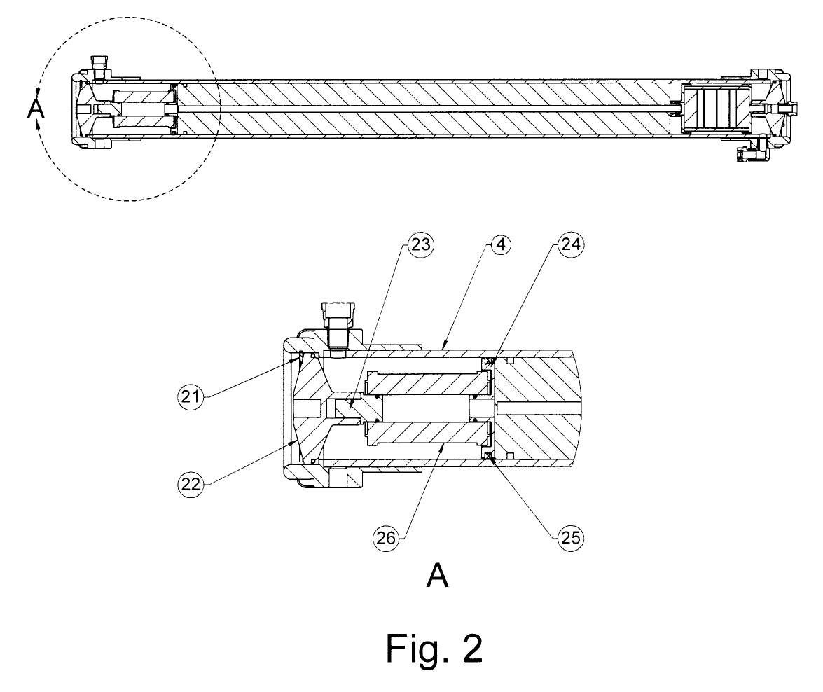

FIG. 2 shows a cutaway view of a purification system with further detail of proximal end A which is the inlet end of the system. One end of Carbon/Sediment filter 26 is held in place by outlet adaptor 24 and seals to the inside of outer shell housing 4 with chevron seal 25. The other end of Carbon/Sediment filter 26 is supported by inlet adaptor 23 which is held in place by pressure vessel plug 22. Pressure vessel plug 22 is retained in housing 4 with snap ring 21. Carbon/Sediment filter 26 can be easily replaced by removing snap ring 21 and then plug 22.

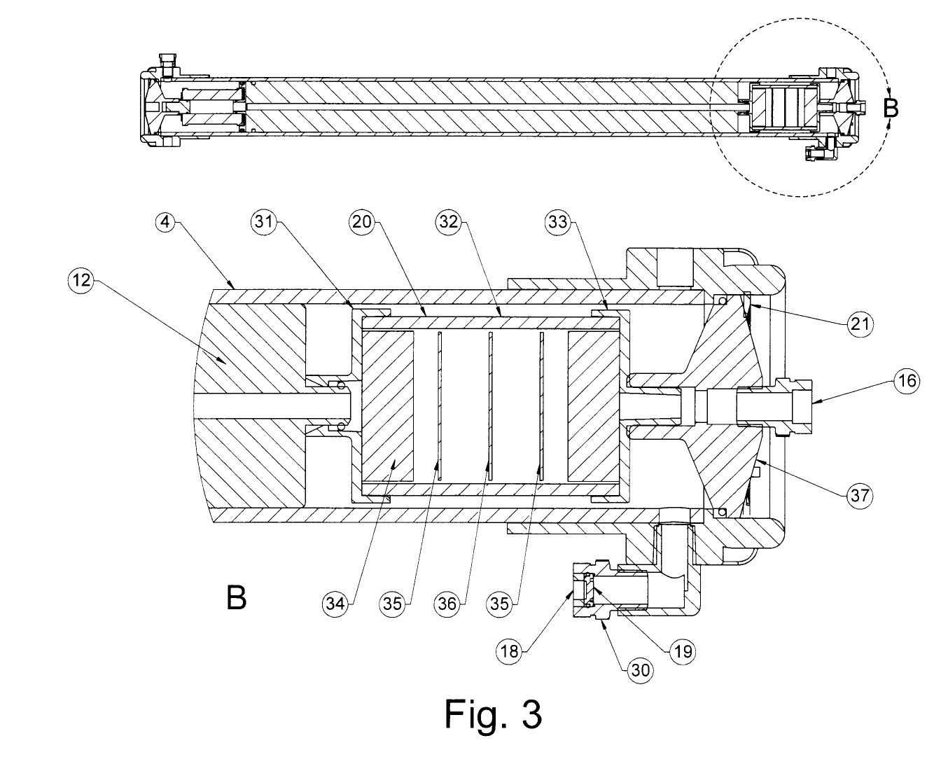

FIG. 3 shows a cutaway view of a purification system with further detail of proximal end B which is the outlet end of the system. The deionize resin cartridge 20 is comprised of a housing assemble made with inlet cap 31, cylinder 32 and outlet cap 33. The end caps 31 and 33 have filter material 34 fixed to the inside surface as to retain the resin inside the housing assembly. The inside of the housing is filled with the deionize resin and may also be layered between baffles 35 and 36 to cause complete exposure to the resin by the permeate water flow. Inlet cap 31 seals to the outside diameter of the core tube on RO membrane 12. Outlet cap 33 seals to the inside diameter of pressure vessel plug 37 and is retained in pressure vessel 4 with snap ring 21. Purified water outlet fitting 16 connects to the outlet of plug 37. Waste water exits the system at port 18. The waste water connection fitting 30 may house a flow control device 19 which automatically regulates the flow of waste water to the correct proportional ratio to permeate production

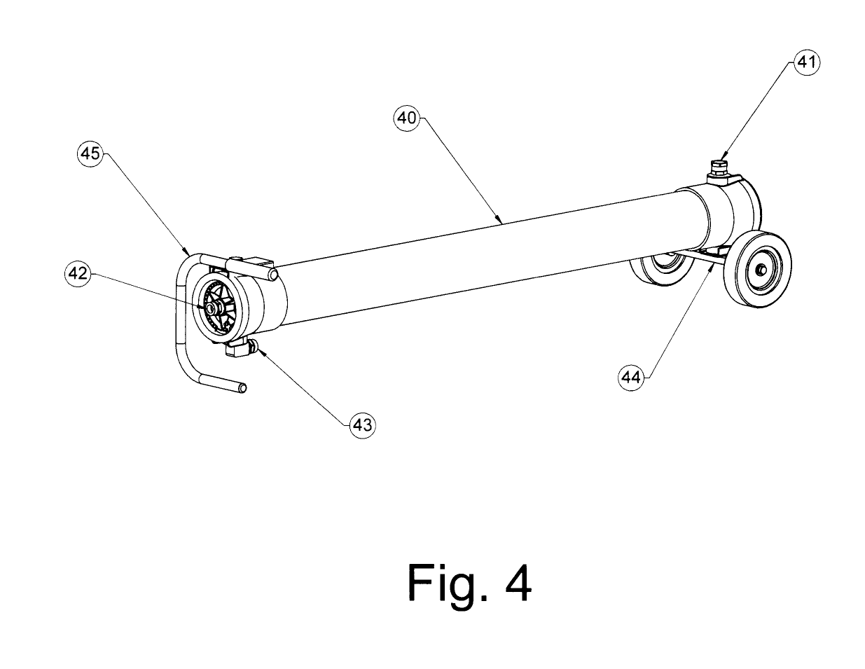

FIG. 4 shows one configuration of a purification system in a normal operation position. Transport wheel assembly 44 and handle assembly 45 allow for easy movement of the system. A supply water hose is connected to fitting 41. The waste water hose is connected to fitting 43 and directs the flow to an appropriate drainage area. A hose used to direct the purified water to the usage site is connected to fitting 42.

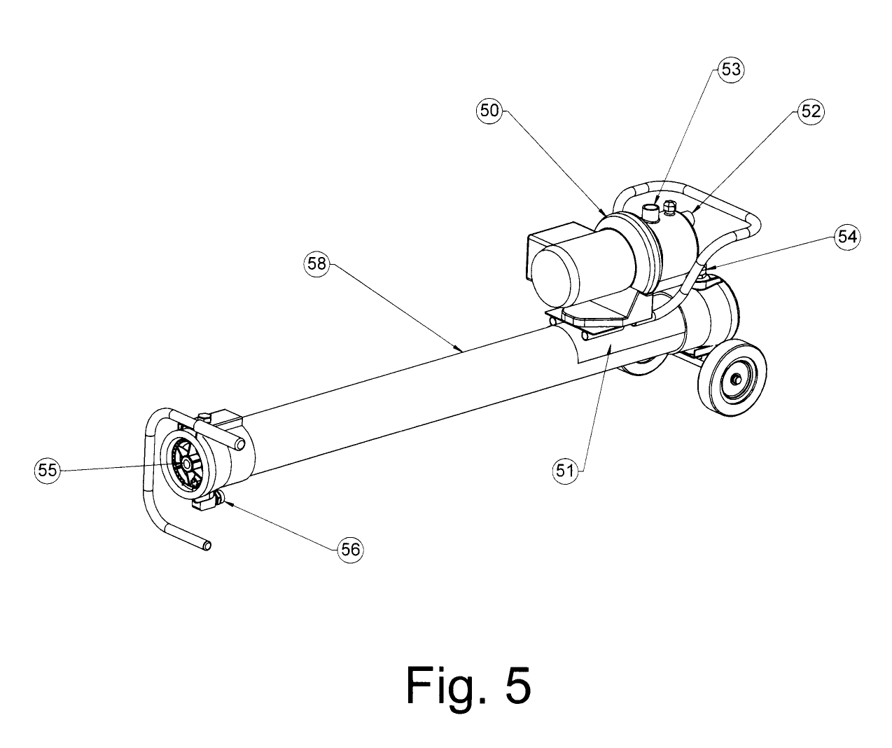

FIG. 5 shows one configuration of a purification system in a normal operation position with a feed water boost pump mounted to the pressure vessel housing. Feed water boost pump 50 is affixed to mounting frame 51, which attaches to pressure vessel housing 58. A supply water hose is connected to pump fitting 52. An intermediate hose connects the pump discharge port 53 to pressure vessel inlet port 54. The waste water hose is connected to fitting 56 and directs the flow to an appropriate drainage area. A hose used to direct the purified water to the usage site is connected to fitting 55.

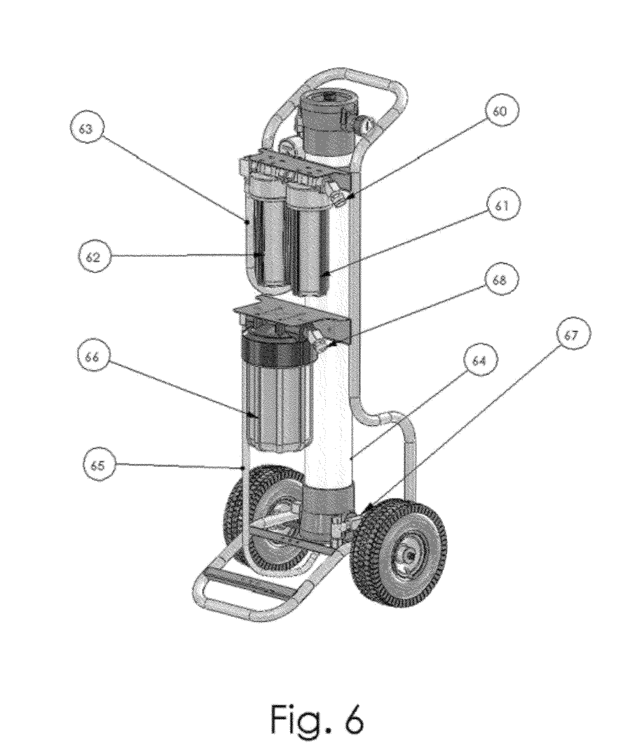

FIG. 6 show one example of a portable design for a purification system. Supply water hose is connect to inlet fitting 60. Water flows through sediment filter assembly 61 then through carbon filter assembly 62. This pre-condition feed water is directed to the RO membrane pressure vessel 64 via hose 63. The product water from the RO membrane flows through line 65 to deionize resin filter assembly 66. A hose used to direct the purified water to the usage site is connected to outlet fitting 68. The waste water hose is connected to fitting 67 and directs the flow to an appropriate drainage area.

1) A water improvement container comprising:
a) an elongated housing;
b) a water entry port adjacent one proximal end of the housing which receives supply water;
c) two water exit ports adjacent one distal end of the housing;
i) a first of the two water exit ports venting waste water; and
ii) a second of the two water exit ports venting product water having lower concentrations of at least some dissolved materials than both the supply water and the waste water;
d) the water port providing supply water first to a macrofilter within the housing that filters at least solid particles and chlorine from the supply water to form an intermediate water source;
e) the intermediate water source exiting the macrofilter flowing into a reverse osmosis membrane
f) the intermediate water being separated into two streams, one stream having at least 98% by weight of dissolved alkaline cationic materials or alkali cationic materials removed from the intermediate water and a second stream having less than 2% by weight of dissolved alkaline cationic materials or alkali cationic materials removed from the intermediate water;
g) the first stream being vented out of the housing through the second of the two water exit ports; and
h) the second stream being vented out of the housing as waste water through the first of the two water exit ports.

2) A water purification container comprising:
a) an elongated housing;
b) a water entry port adjacent one proximal end of the housing which receives supply water;
c) two water exit ports adjacent one distal end of the housing;
i) a first of the two water exit ports venting waste water; and
ii) a second of the two water exit ports venting product water having lower concentrations of at least some dissolved materials than both the supply water and the waste water;
d) the water port providing supply water first to a combination macrofilter/carbon block filter within the housing that filters at least solid particles and chlorine from the supply water to form an intermediate feed water source for a reverse osmosis membrane; and
e) the intermediate water source exiting the macrofilter flowing into a chamber housing a reverse osomosis membrane;
f) the intermediate water being separated into two streams, one stream having at least 98% by weight of dissolved alkaline cationic materials or alkali cationic materials removed from the intermediate water and a second stream having less than 2% by weight of dissolved alkaline cationic materials or alkali cationic materials removed from the intermediate water;
g) the first stream being vented out of the housing through the second of the two water exit ports; and
h) the second stream being vented out of the housing as waste water through the first of the two water exit ports.

3) The purification container of claim 2 wherein intermediate feed water exiting the macrofilter/carbon block filter flows into the inlet side of the reverse osmosis membrane.

4) The purification container of claim 2 wherein the intermediate water source exiting the macrofilter flows into an ion exchange filter region that removes at least dissolved alkaline cationic materials or alkali cationic materials from the intermediate water.

5) The purification container of claim 2 wherein product water is directed through a series of baffles in the resin bed to ensure use of the resin.

6) The purification container of claim 2 wherein of claim 5 wherein an ion exchange resin removes dissolved solids from the product water.

7) The purification container of claim 2 wherein product water flows out from the ion exchange housing and is directed to a point of use.

8) The purification container of claim 2 wherein the second stream of water is concentrated water exiting the reverse osmosis membrane and is automatically regulated by a flow control device.

9) The purification container of claim 2 wherein the second stream of water moves towards the exit port of the main system housing in a gap between the outside diameter of the ion exchange resin bed housing and the inside diameter of the main system housing.

10) The purification container of claim 2 wherein the first stream being vented out of the housing through the second of the two water exit ports; and the second stream being vented out of the housing as waste water through the first of the two water exit ports.

11) The container of claim 1 wherein the macrofilter comprises a fibrous or particulate based filter in combination or separately a carbon block filter composition.

12) The container of claim 1 wherein houses a semipermeable membrane.

13) The container of claim 2 wherein the container houses a semipermeable membrane.

14) A water improvement container comprising:
a) an elongated housing;
b) a water entry port adjacent one proximal end of the housing which receives supply water;
c) two water exit ports adjacent one distal end of the housing;
i) a first of the two water exit ports venting waste water; and
ii) a second of the two water exit ports venting product water having lower concentrations of at least some dissolved materials than both the supply water and the waste water;
d) the water port providing supply water first to a macrofilter within the housing that filters at least solid particles and chlorine from the supply water to form an intermediate water source;
e) the intermediate water source exiting the macrofilter flowing into a reverse osmosis membrane
f) the intermediate water being separated into two streams, one stream having at least 85% by weight of dissolved alkaline cationic materials or alkali cationic materials removed from the intermediate water and a second stream having less than 15% by weight of dissolved alkaline cationic materials or alkali cationic materials removed from the intermediate water;
g) the first stream being vented out of the housing through the second of the two water exit ports; and
h) the second stream being vented out of the housing as waste water through the first of the two water exit ports.
